(19) United States
(12) Patent Application Publication
(10) Pub. No.: US 2017/0149864 A1
(43) Pub. Date: May 25, 2017

(54) DISTRIBUTED APPLICATIONS MANAGEMENT WITH DEPENDENT RESILIENT DISTRIBUTED SERVICES

(71) Applicant: International Business Machines Corporation, Armonk, NY (US)

(72) Inventors: Michael Feiman, Richmond Hill (CA); Lei Guo, Markham (CA); Jason T. S. Lam, Markham (CA); Zhimin Lin, Scarborough (CA); Ting Xue, Richmond Hill (CA)

(21) Appl. No.: 14/949,983

(22) Filed: Nov. 24, 2015

(51) Int. Cl. H04L 29/08

(52) U.S. Cl. CPC H04L 67/10; H04L 67/16

(57) ABSTRACT

A system for managing a distributed service may include one or more compute nodes, with each compute node having one or more computer processors and a memory. The system may additionally include: a set of software services, the set of software services including the distributed service; a configuration manager to store configuration information about the distributed service, including a criteria for transitioning the distributed service from a first execution state to an initialization state, the criteria associating the execution first state with a second execution state of a first service of the set of software services; a set of measuring agents to obtain execution information from the set of software services; an execution system configured to: determine, based on the execution information, whether the criteria is satisfied; and transition, in response to determining that the criteria is satisfied, the distributed service from the first execution state to the initialization state.

### BACKGROUND

The present disclosure relates to computer software, and more specifically, to an architecture for managing the execution of distributed services on a computing system.

In the field of computing systems, distributed architectures include software services having components distributed across several computing devices of a computing system. These distributed software services may comprise an aggregation of distributed components which may include multiple instances of the same process type executing on one or more computing device (e.g., where the computing system is a cluster computing system having a plurality of computing nodes, each distributed component may have processes executing on a different node of the cluster). The execution of the distributed application may depend on the execution state of the distributed components, as well as the execution state of other software services or applications executing on the computing system.

### SUMMARY

According to embodiments of the present disclosure, a system for managing a distributed service may include one or more compute nodes, with each compute node having one or more computer processors and a memory. The system may additionally include a set of software services executing on the one or more processors. The set of software services may further include the distributed service. Furthermore, the system may include a configuration manager executing on the one or more processors to store configuration information about the distributed service, with the configuration information including a first criteria for transitioning the distributed service from a first execution state to an initialization state. The first criteria may associate the first execution state of the distributed service with a second execution state of a first service of the set of software services. Additionally, the system may include a set of measuring agents executing on the one or more processors to obtain execution information from the set of software services. Furthermore, the system may include an execution system executing on the one or more processors and coupled to the configuration manager and the set of measuring agents, the execution system configured to: determine, based on the execution information, whether the first criteria is satisfied; and transition, in response to determining that the first criteria is satisfied, the distributed service from the first execution state to the initialization state.

Other embodiments are directed towards methods and computer program products for managing a distributed service.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of a distributed computing system for implementing a framework for managing execution of distributed applications, according to various embodiments.

FIG. 2 depicts a block diagram of components of a distributed service and associated applications, according to various embodiments.

FIG. 3 depicts a block diagram of a set of states of a service instance associated with a component of a distributed service, according to various embodiments.

FIG. 4 depicts a diagram of a set of states of a distributed service, according to various embodiments.

FIG. 5 depicts a flowchart of a set of operations for managing execution of a distributed service, according to various embodiments.

FIG. 6 depicts a block diagram of a computing device for implementing the framework for managing execution of a distributed application, according to various embodiments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to computer software, more particular aspects relate to an architecture for managing the execution of distributed services on a computing system. While the present disclosure is not necessarily limited to such applications, various aspects of the disclosure may be appreciated through a discussion of various examples using this context.

A distributed service (or distributed application) executing on a computing system may experience a failure during the course of its execution due to a failure in one of its distributed components (e.g., a process instance). A process instance may fail due to internal logic inconsistencies and external or environmental factors such as data communication or disk drive failures. These failures may manifest themselves as a change in an internal execution state of the process instance, or as an unscheduled termination of the process instance. Error handling algorithms implemented by a host computing system or a distributed application may attempt to recover from a failure in a process instance by restarting the failed process instance, the distributed application, and/or other dependent applications or processes.

A failure recovery procedure implemented by a host computing system or distributed service may enable a failure of a single process instance to cause the execution of a cascading chain of recovery operations spanning several computing devices. This chain of recovery operations may include, for example, the restarting, reallocation and reconfiguration of several process instances and distributed services. Embodiments of the present disclosure are based on the recognition that the cost of recovery operations in a computing system may be mitigated by architecturally determining when to start and stop distributed services in response to process failures.

Embodiments of the present disclosure are directed towards an architecture for managing the execution of distributed services by creating a framework for specifying dependencies between services, and for monitoring and controlling the execution states of these services. A dependency may be a condition precedent or a criteria that must be satisfied for a distributed service to transition from, and into, a given execution state. The condition or criteria may depend on the execution state of one or more other services executing on a computing system. The architecture may enable computing systems and distributed services to mitigate the cost of recovering from process failures by providing a mechanism, at a system level (e.g., external to a given service or application), for specifying sequences for starting and stopping services executing on the computing systems. This may mitigate the effects caused by the chaining or cascading of recovery operations across services of a computing system.

A distributed service, for example, may externally specify a set of dependencies for transitioning from an execution state to an initialization state (e.g., a criteria for stopping the execution of a distributed service). The distributed service may additionally provide a set of externally defined methods for monitoring the internal states of the distributed service. A computing system may use the dependences and the internal state information to detect internal (or external) failures in a distributed service, and determine whether to restart the distributed service or continue execution of the application in a determined execution state. This may reduce the likelihood of a distributed service being restarted unnecessarily in response to a failure.

In some embodiments, a distributed service may specify a criteria (e.g., dependencies) for remaining in (or for transitioning to) a given execution state based on execution states of internal components of the distributed service. In certain embodiments, the criteria may be based on execution states of other services executing on a computing system. The distributed service, or components of the distributed service, may include an interface for externally providing information about the service's internal execution state. Process monitoring tools may couple to the interface, providing execution information about the distributed application to a computing system. The computing system may determine, based on provided execution information, whether the specified criteria is satisfied. The computing system may then alter the execution of the application based on the determination.

As used herein, a distributed service may be a software application having one or more components executing on nodes of a computing system (e.g., a cluster computing system). The components of a distributed service may include instances of identical processes (hereinafter, service instances) executing on the different nodes. A service instance may be in one of a set of (e.g., one or more) executions states (described infra) during the course of its execution on a computing node. A computing system may track the aggregate states of the service instances using a logic construct or data structure (hereinafter, a “logical instance”). The aggregate states of the service instances associated with a distributed service and represented by the logical instance may determine or characterize the execution state of the distributed service.

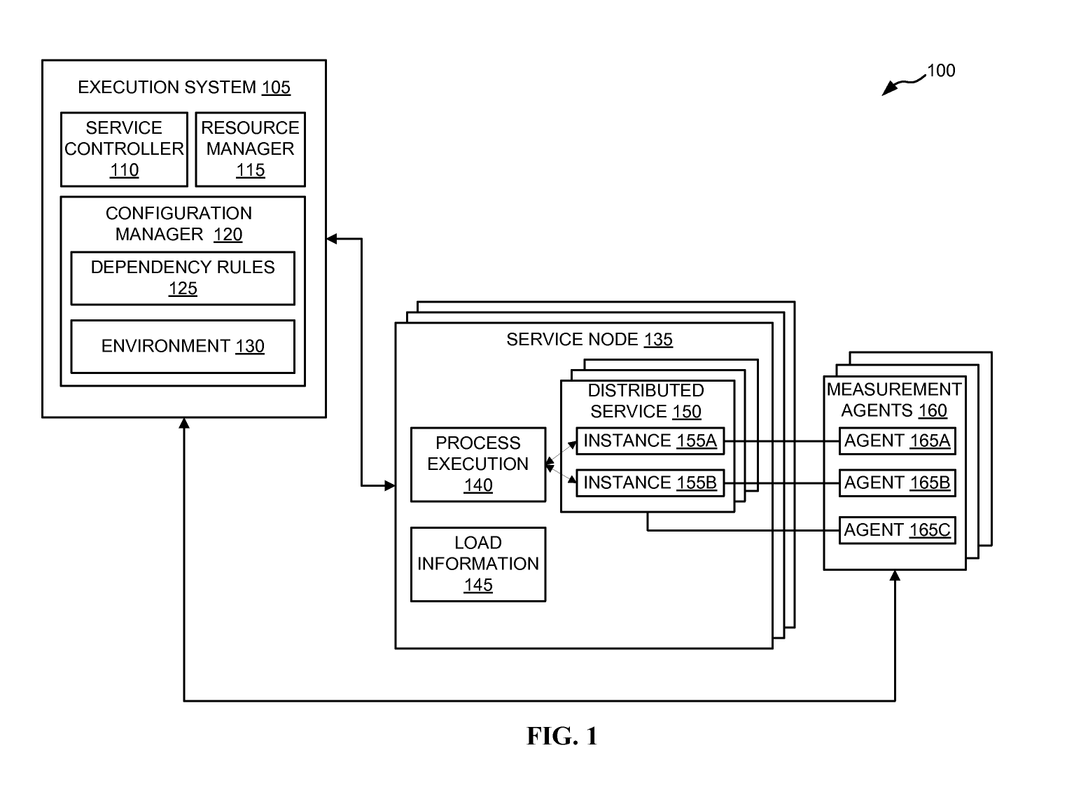

Referring now to the figures, FIG. 1 depicts a block diagram of a distributed computing system 100 for implementing a framework for managing execution of distributed services, according to various embodiments. The distributed computing system 100 (hereinafter, computing system 100) may include a cluster computing environment configured to provide distributed services to client computing devices or end users. As shown in FIG. 1, the distributed computing system may include an execution system 105, a set (e.g. one or more) of service nodes 135, and a set of measurement agents 160. In some embodiments, the measurement agents 160 may execute on the execution system 105, while in other embodiments, the measurement agents 160 may execute on the service nodes 135.

The execution system 105 may be a managing component of the distributed computing system 100, such as a cluster master in a cluster computing system. In some embodiments, the execution system 105 may be a single computing device, or a set of computing devices. Furthermore, components of the execution system 105 may include software resources (e.g., databases, tables, software applications and services) and/or hardware resources (e.g., memory, processing devices, and storage). The software and/or hardware resources may reside in, or execute on, a single computing device or set of computing devices.

The execution system 105 may include a service controller 110, a resource manager 115, and a configuration manager 120. The service controller 110 may manage execution of service instances on the behalf of the execution system. The service controller 110 may, for example, allocate resources to a service instance. The service controller 110 may also issue commands to process execution units 140 to start and stop service instance on service nodes 135. The resource manager 115 may collect resource capacity information (e.g., the quantity and type of resources available) from service nodes 135. Service controller 110 may use the resource capacity information to determine where to allocate resources to service instances. The configuration manager 120 may maintain a database of configuration information for each service executing on the distributed computing system 100. The configuration information may include dependency rules 125 and environment data 130 associated with each service.

The execution system 105 may receive, from a user (e.g., a system administrator, end user, or client computing system), service registration information for a distributed service that is to execute on the computing system. The registration information may be received as a service definition file or data structure. The service definition file or data structure may include a command for executing an instance of the service on the distributed computing system 100. The service definition file or data structure may also include operating system (or computing system) specific parameters and environment variables. The service definition file or data structure may further include statistics indicating, for example, the maximum number of service instances which the distributed service may instantiate and a minimum number of services instances which is sufficient for the distributed service to properly execute. The service definition file may further include a set of criteria specifying at least one of two types of dependencies on other services: a startup dependency and a keeping dependency.

A startup dependency may be specified as a criteria for transitioning a distributed application from an initialization state to an execution state. In some embodiments, the startup dependency may be provided as a tuple having at least two elements: a named service (e.g., an identifier of a service), and a set of satisfying execution states. The named service may indicate a service on which a dependent distributed service associated with the service definition has an antecedent dependency. The startup dependency may require that the named service be in at least one of a required set of execution states (specified by the satisfying states tuple element) before the distributed service may transition to an execution state.

In certain embodiments, each service provided in the startup dependency list may be required to be in at least one of the indicated states for the dependent service to transition to an execution state. In some embodiments, at least one of the services provided in the startup dependency list may be required to be in at least one of the indicated states for the dependent service to transition to an execution state.

A keeping dependency may be specified as a criteria for transitioning a distributed service from an execution state to, for example, an initialization state. In some embodiments, the keeping dependency may be specified as a criteria for allowing a service (e.g., the dependent service) to continue in a given execution state. In some embodiments, the keeping dependency may be provided as a tuple having at least two elements: a named service (e.g., an identifier of a service), and a set of satisfying execution states. The named service may indicate a service that a dependent service associated with the service definition has a concurrent dependency on. The keeping dependency may provide that the dependent service may continue executing when the named service is in at least one of a one of a given set state of execution states (specified by the satisfying states tuple element).

In certain embodiments, each named service provided in the keeping dependency list may be required to be in one of the indicated states for the dependent application to remain in an execution state. In some embodiments, at least one of the named services provided in the keeping dependency list may be required to be in one of the indicated states for the dependent application to remain in an execution state.

The service definition file or data structure may be parsed by a component of the execution system 105 and stored in configuration manager 120. For example, the startup and keeping dependency rules may be stored in dependency rules component 125 (e.g., a database or table that maintains the set of dependency rules for all service instances executing on a computing system). Similarly, environment and operating system related information or parameters may be stored in environment component 130. In some embodiments, the service instance execution command may also be stored in configuration manager 120. The registration information may be provided to the service controller 110 or other components of the execution system 105 via inter-process or application communication links.

Service node 135 may be a computing node (e.g., a computing device) of the distributed computing system 100. In some embodiments, service node 135 may be configured with a set of hardware and software resources for executing components of distributed services (e.g., service instances) allocated to execute on the node. The service node 135 may include process execution unit 140, load information unit 145, and distributed services 150. In some embodiments, service node 135 may additionally include measurement agents 160.

Process execution unit 140 may include software applications for managing the execution of components of a distributed service on the service node 135. The process execution unit 140, for example, may receive a command to start a service instance from the execution system 105 (e.g., the command may be dispatched from service controller 110). Process execution unit 140 may then allocate resources for, and execute, the service instance (e.g., instance 155A and 155B) on the local service node 135. Similarly, process execution unit 140 may stop the execution of a service instance in response to a command or request received from the execution system 105.

Load information manager 145 may include software applications or services for providing information about resources available on the service node 135. The load information manager 145 may, for example, monitor the disk, processor, and memory usage and capacity of service node 135. The load information manager may then provide the usage and capacity information to execution system 105.

Distributed services 150 may be the collection of service instances 155A and 155B (e.g., instances of a single process type) belonging to a distributed service and executing on service node 135.

Measurement agents 160 may be a collection of process monitoring tools (e.g., agents 165A-165C) for monitoring and reporting the internal execution state of service instances. In some embodiments, each service instance 155 of a distributed service executing on service node 135 may have an associated process monitoring tool. A service instance may define publically accessible methods or functions (e.g., an interface) for providing the process monitoring tools access to internal (e.g., within the code or memory space of the executing instance/process) execution state information about the service instance. Commands and/or interface protocols for executing and retrieving execution state information from a process monitoring tool or agent may be provided to the execution system 105 during registration of a distributed service.

The following is an example scenario of managing a distribute service on the distributed computing system 100. Execution system 105 may receive a request from a user to register a data processing service (e.g., a distributed service). The request may include a service definition data structure. The data structure may include an operating system command for starting a set of service instances of the data processing service. The service definition data structure may also include environment and operating system related information, dependency rules, and commands for starting instance monitoring tools. The execution system 105 may transfer the service definition file to configuration manager 120 for processing (e.g., parsing and storage).

Once the data processing service is registered, the service controller 110 may access the registration information to retrieve the executing commands for starting instances of the data processing service. The service controller 110 may also retrieve information about the minimum number of service instances required to start the data processing service. Additionally, the service controller may retrieve dependency rules or criteria for executing the data processing service. The service controller may then request that resource manager 115 allocate resources required to execute each service instance. In some embodiments, the service controller may create (or instantiate) a logical instance of the data processing service for tracking the aggregate execution state of the service. In some embodiments, location of the management instance may be provided to the configuration manager 120 to use in establishing communication with later instantiated instances of the data processing service.

The service controller 110 may then determine whether service instances of the data processing service may be started (e.g., whether startup dependencies for the service instances have been satisfied). The service controller 110 may then proceed to start (e.g., execute) at least the minimum number of service instances (and associated monitoring agents 165) required to execute the data processing service. Starting up the service instances may include loading the service instance into a memory of service nodes 135 and transferring execution of the service node to the service instance. In some embodiments, the service controller 110 may retrieve and store location information for each started service instance. In some embodiments, the location information may be any communication parameter (e.g., a service node's address and a software communication port number) suitable for establishing communication with a service instance.

The service controller may make the location information available to service instances via, for example, process execution unit 140. In some embodiments, a newly started service may use the location information to establish communication between itself and another existing service instance.

The service controller 110 may then determine whether internal startup requirements and (external) startup dependencies for the data processing service has been satisfied. For example, an internal startup requirement for the data processing application may specify that at least 10 service instances belonging to the data processing service must be in an execution state. A startup dependency may specify that a database management service must be in an execution state (e.g., a “Started” state). This startup dependency may be embodied in the database management service as a requirement that a service instance of the database management service be executing on each service node 135 having one of the 10 data processing service instances. The service controller 110 may transition the aggregate state of the data processing service to an executing state after determining that at least 10 data processing service instances are in an execution state (e.g., by querying monitoring agents 165) and the database management service is executing in a Started state, as described herein.

When a service instance or an instance of the database management service experiences an execution failure, the service controller 110 may stop the instance and restart it at a later time. The service controller 110 may also check the keeping dependency of the data processing service to determine whether the service may continue executing. The keeping dependency for the data processing service, for example, may require the database management service be in a Started state. The database management service's internal requirements may further specify that at least 3 service instances of a database management service must be executing in a Run state for the application to remain in a Started state. Assuming an initial state of the computing system 100 where there are four service instances on the database management service in execution in Run states (as described herein) on service node 135, the service controller 110, after detecting (e.g., from monitoring agents 165) a failure forcing the termination of one service instance of the database management service, may allow the data processing service to continue executing because the data processing service's keeping dependencies are still satisfied (e.g., because the database management service remains in the Started state due to 3 service instances still executing in Run state). However, after detecting a subsequent failure that causes the termination of a second service instance of the database management service, the service controller may determine that the data processing service's keeping dependencies are no longer satisfied. The service controller may then terminate the data processing application. Terminating and restarting the data processing application may include directing the processing execution unit 140 on each service node 135 to stop service instances associated with the data processing application. Terminating the data processing application may further include bringing the data processing service back to an initialization state by, for example, releasing all resources allocated to the application.

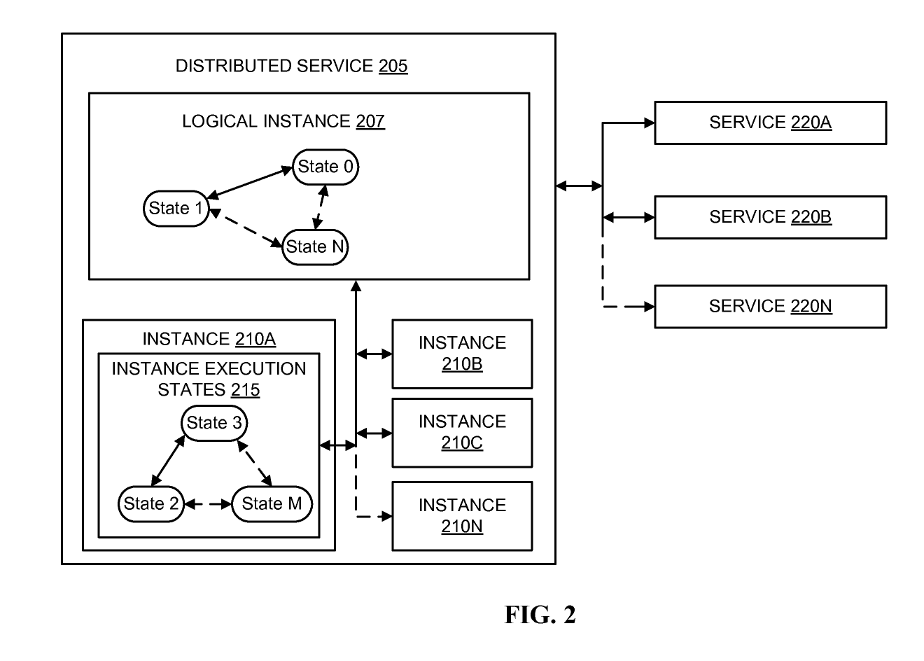

FIG. 2 depicts a block diagram of components of a distributed service 205 and associated services 220A-220N, according to various embodiments. The distributed service 205 may include a logical instance 207 and service instances 210A-210N. The logical instance 207 may be a data structure representing the aggregate states of the distributed service 205. The logical instance 207 may reside in a memory of execution system 105 (or, service controller 110), and may be used to track the aggregate state of the distributed service 205. In some embodiments, the logical instance 207 may indicate that the distributed service 205 is in one of a set of states (e.g., state 0 through state N). A first state (e.g., state 0) may be an initialization state while other states (e.g., states 1 through state N) may be execution states. An initialization state may be a non-execution state (e.g., computer readable code associated with an instance in this state is not being executed by a processor). An execution state may be characterized as a state where an instance is being executed, or is queued to be executed, by a processor of a node associated with a computing system. The aggregate state of the distributed application represented by the logical instance 207 may be transitioned from an initialization state to one of a set of execution states when all startup dependencies on other services are satisfied, resources are allocated to start service instances, and a sufficient number of services instances are started on a computing system, as described herein. In some embodiments, the logical instance 207 may remain or continue in an execution state while all keeping dependencies defined for the distributed application 205 are satisfied. In certain embodiments, the aggregate state of the distributed application represented by the logical instance 207 may be transitioned to an initialization state when at least one keeping dependency is not satisfied. The distributed application's 205 startup and/or keeping dependencies may include requirements on the execution states of other services, including, for example, services 220A through 220N and service instance 210A-210N.

In addition to the logical instance 207, the distributed application 205 may include a set of service instances 210A-210N. The process execution cycle of each service instance 210A-210B may be characterized by a sets states 215 (e.g., state 2 through state M), including, for example initialization and execution states. Service instances 210A may transition between states based on internally defined requirements for the service instance, as described herein.

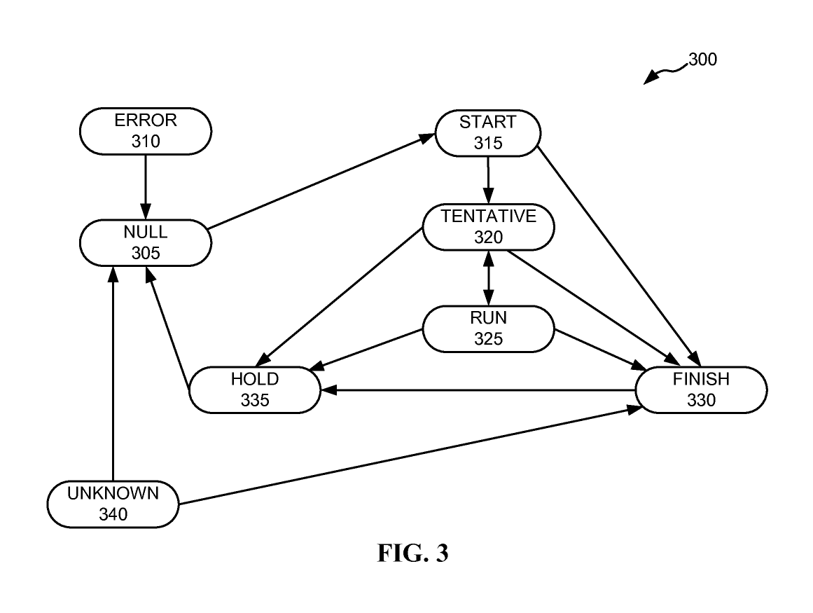

FIG. 3 depicts a block diagram of a set of states 300 of a service instance associated with a component of a distributed service, according to various embodiments. The set of states 300 may be an embodiment of the set of states (e.g., states 3 through state M) associated with a service instance 210 (FIG. 2). In some embodiments, a service controller, such as service controller 110 (FIG. 1), may maintain state information for each service instance of a distributed service. The service controller may update the state information based of information received from, for example, a process monitoring agent such as agents 165 (FIG. 1). In other embodiments, the state information may be maintained by the service instance and reported a service controller by process monitoring agent.

A null state 305 indicates that the service instance may be a non-execution state. In some embodiments, the service instance in null state 305 may not be currently loaded in a memory of a computing system (e.g., the service instance does not currently exists on the computer system). Start state 315 indicates that service controller 110 allocated resource, via resource manager 115, for the service instance, and has sent startup information to corresponding process execution 140.

Tentative state 320 may indicate that a service instance has started executing on service node 135. A service instance may remain in a tentative state 320 until an associated measurement agent 160 (FIG. 1) reports to the service controller that the service instance is fully initialized. The service controller may then transition the service instance to an execution state (e.g., a Run state). Run state 325 indicates that a service instance is fully initialized and is executing the computing system. Hold state 335 indicates that execution of a service instance has been suspended, but the service instance is still in the memory of the computing system. The measurement agent 160 (FIG. 1) may continue to monitor the service instance and later can downgrade the service instance's state back to TENTATIVE state 320 when the service instance's internal conditions change (while the service instance continues executing). The service instance's state may transition to Finish state 330 when the service instance stops executing. Unknown state 340 and/or error state 310 may indicate an execution failure.

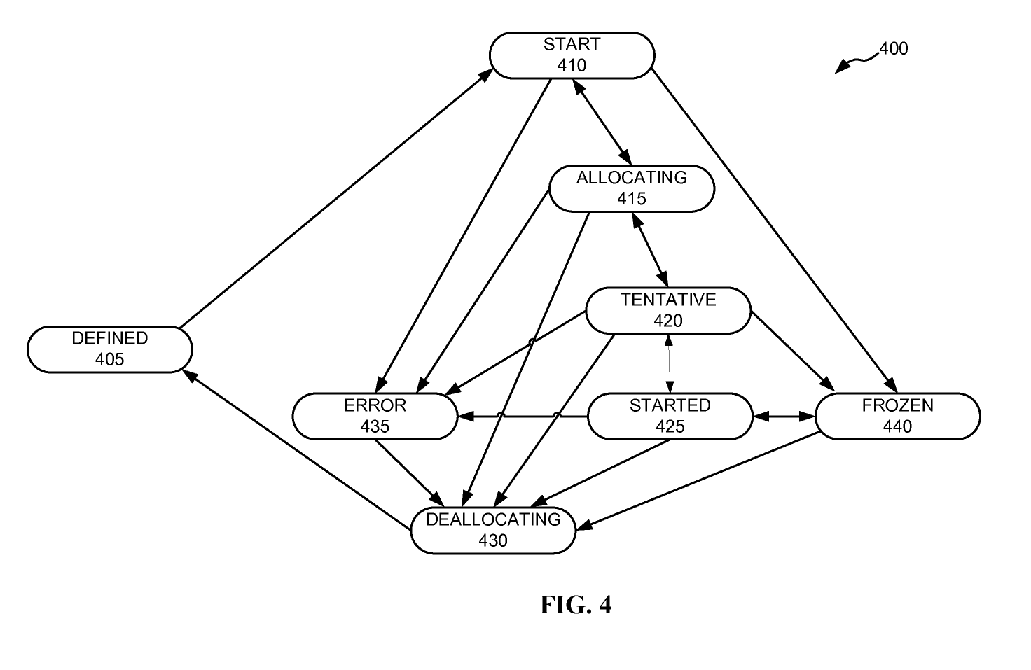

FIG. 4 depicts a diagram of a set of states 400 of a distributed service executing on a computing system, according to various embodiments. The set of states 400 may be an embodiment of the set of states (e.g., states 0 through state N in FIG. 3) representing the aggregate state of the distributed application as maintained by the logical instance 207 (FIG. 2). The service state may be decided by a service controller based on the number and state of its already existing service instances taking into account service configuration parameters, such as the maximum and minimum number of service instances required for the distributed service. The service controller may update the state information based of information received from, for example, process monitoring agents.

Defined state 405 indicates that the distributed service is registered with an execution system on a computing system (e.g., the execution system has received a service definition file or data structure for the distributed service). Start state 410 indicates that a user has requested that the distributed service be started by the execution system. In some embodiments, the execution system may load the distributed service into a memory of the computing system in start state 410. An execution system may transition a distributed service from the Start state 410 (e.g., an initialization state) to Allocating state 415 after determining the startup dependencies defined for the distribute service are satisfied, as described herein. Allocating state 415 may indicate that the execution system is in the process of allocating resources for executing the distributed service. Allocating resources may include reserving resources (e.g., a service node, and memory), and starting service instances required using the reserved resources. Tentative state 420 may indicate that the distributed service is ready to begin execution (e.g., the number of started service instances have reached a predetermined minimum number required to start the distributed service). In some embodiments, the previously mentioned states (405, 410, 415, and 420) may be referred to as initialization states. A distributed service may be transitioned to the Started state 425 (e.g., an execution state) when a minimum number of service instances are in the Run state 325 (FIG. 3). In some embodiments, the execution system may evaluate keeping dependencies on another service during the Allocating 415, Tentative 420 and Started 420 states, as described herein. When the keeping dependencies are not satisfied, the execution system may terminate all service instances, release allocated resources, and transition the distributed service's state back to Start state 410. A distributed service may transition to error state 435 or frozen state 440 when there is an execution failure. In deallocating state 430, execution of the distributed served may be terminated and resources allocated to the service may be freed or returned to the computing system.

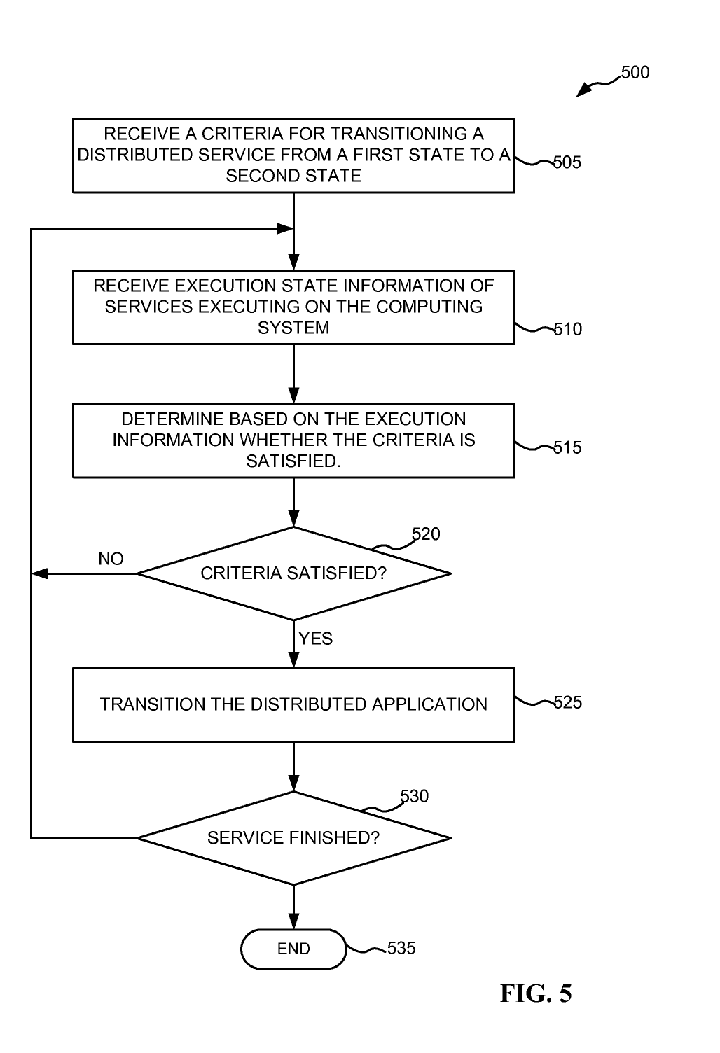

FIG. 5 depicts a flowchart 500 of operations for managing execution of a distributed service, according to various embodiments. The operations of the flowchart 500 may be executed by an execution system such as the execution system 105 (FIG. 1). These operations may be used to provide resilient management of distributed services, including recovery from execution failures in a distributed service having dependencies on internal components of the distributed service as well as dependencies on other external services.

The execution system may begin executing the operations of flowchart 500 at operation 505 by receiving a criteria for transitioning a distributed service from a first state to a second state. The execution system may receive the criteria as part of a service definition file or data structure. In some embodiments, the received criteria may be a startup dependency, specifying requirements for transitioning the distributed service from an initialization state to an execution state. In certain embodiments, the received criteria may be a keeping dependency, specifying requirements for the distributed service to continue to execute on a computing system (e.g., requirements for transitioning the distributed service from an execution state to an initialization state or “defined” state).

The received criteria may specify dependencies or requirements based on the execution states of other services executing on the computing system (e.g., a criteria may specify that at least two services of a given type be in an execution or tentative state before the distributed service can be transitioned to an execution state). In some embodiments, these dependencies may reflect requirements on the aggregated states of a service's executing instances.

Keeping and start dependencies may indicate an order for starting and stopping services on a computing system. A distributed service, for example, may not proceed from an initialization state to an execution state until all start dependencies are satisfied. This may imply a startup order (or sequence) because a distributed service having a startup dependency on another service may not begin execution until the other service is in a specified execution state (e.g., the other service has started). Similarly, a computing system may not transition a distributed service from an execution state to an initialization state (e.g., the distributed service may not be showdown) while keeping dependencies are satisfied. This may imply an order (or sequence) for stopping services as the distributed service may be shutdown or stopped while an antecedent service (e.g., another service whose execution state the keeping dependence is based on) is still in a given execution state (e.g., while the antecedent service is still executing or running).

The execution system may continue the operations of flowchart 500 at operation 510 by receiving execution state information about services executing on the computing system. The services executing on the computing system may include external methods or functions for monitoring tools (e.g., measurement agents) to obtain (e.g., via a data communications network, software sockets, or other inter-process communication operations) internal execution state information about the service. The monitoring tools may be software applications or scripts executing on the computing system. In some embodiments, the monitoring tools may provide the execution information to the execution system via a data communication network link or via inter-process communication channel. The execution system may obtain execution commands for starting the monitoring tools in a service definition file or data structure.

The execution system may proceed with the operations of flowchart 500 by executing operation 515. Executing operation 515 may include determining, based on the execution information, whether the criteria received in operation 505 was satisfied. The execution system may aggregate (or collect) execution information received from each service on which the distributed service has a dependency. The execution system may then compare the aggregated execution information against the received criteria to determine whether the received criteria was satisfied. In some embodiments, this operation may include continually aggregating and comparing execution information from dozens or hundreds of processes executing on the computing system.

Operation 520 indicates that the execution system may continue the operations of flowchart 500 at operation 510 when it determines at operation 515 that the received criteria is not satisfied. Operation 520 further indicates that the execution system may continue execution at operation 525 when the execution system determines that the received criteria was satisfied.

The execution system may execute operation 525 by transitioning the distributed service from the first state to the second state. In certain embodiments, this may include transitioning the distributed service from an initialization state to an execution state by, for example, transferring execution of a node of the computing system to the distributed service (e.g., a service instance of the distributed service). In certain embodiments, transitioning the distributed service may include transitioning the distributed service from an execution state to a non-execution state (e.g., an initialization state) by, for example, stopping execution of all processes or instances associated with the distributed service.

According to operation 530, the execution system may continue to operation 535 when the distributed service has finished execution, while the execution system may continue execution at operation 510 when the distributed service has not finished execution. The execution system may execute operation 535 by deallocating resources allocated to the distributed service. In some embodiments, the execution system may attempt to restart failed service instances (e.g., as determined by an exit code) a configurable number of times.

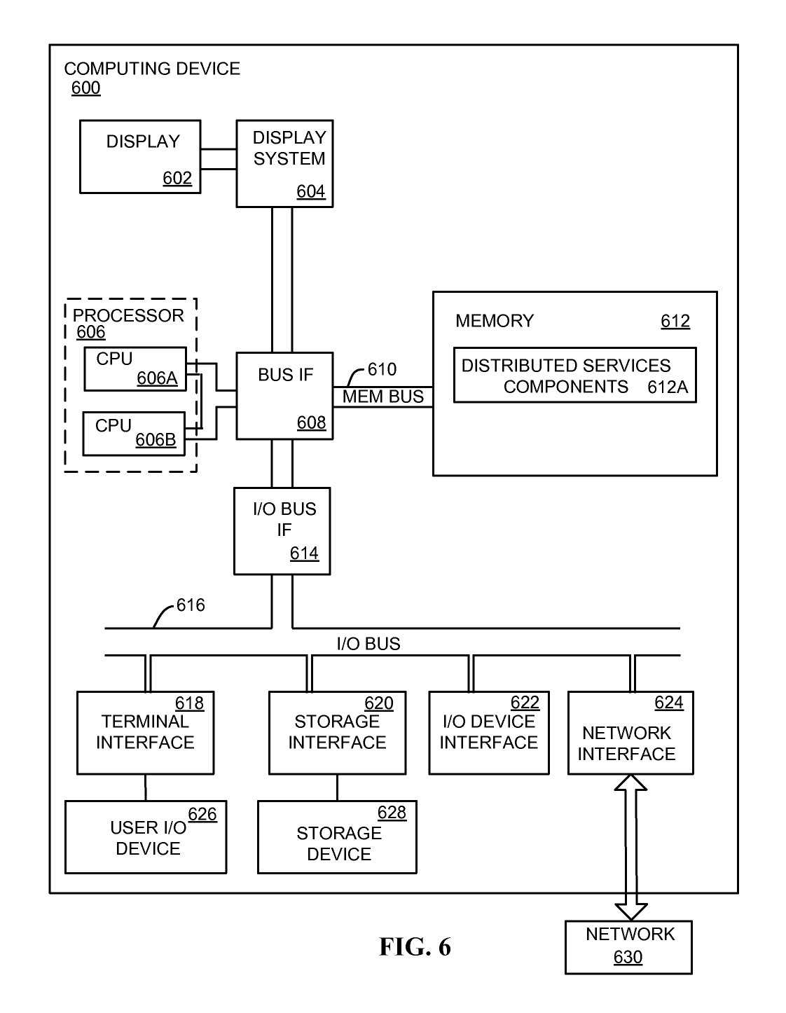

FIG. 6 depicts a block diagram of a computing device 600 for implementing the framework for managing execution of a distributed application, according to various embodiments. The computing device 600 may be a node (e.g., a service node or an execution system) of a cluster computing system configured to execute the operations described herein

The components of the computing device 600 can include one or more processors 606, a memory 612, a terminal interface 618, a storage interface 620, an Input/Output (“I/O”) device interface 622, and a network interface 624, all of which are communicatively coupled, directly or indirectly, for inter-component communication via a memory bus 610, an I/O bus 616, bus interface unit (“IF”) 608, and an I/O bus interface unit 614.

The computing device 600 may include one or more general-purpose programmable central processing units (CPUs) 606A and 606B, herein generically referred to as the processor 606. In an embodiment, the computing device 600 may contain multiple processors; however, in another embodiment, the computing device 600 may alternatively be a single CPU device. Each processor 606 executes instructions stored in the memory 612.

The computing device 600 may include a bus interface unit 608 to handle communications among the processor 606, the memory 612, the display system 604, and the I/O bus interface unit 614. The I/O bus interface unit 614 may be coupled with the I/O bus 616 for transferring data to and from the various I/O units. The I/O bus interface unit 614 may communicate with multiple I/O interface units 618, 620, 622, and 624, which are also known as I/O processors (IOPs) or I/O adapters (IOAs), through the I/O bus 616. The display system 604 may include a display controller, a display memory, or both. The display controller may provide video, audio, or both types of data to a display device 602. The display memory may be a dedicated memory for buffering video data. The display system 604 may be coupled with a display device 602, such as a standalone display screen, computer monitor, television, a tablet or handheld device display, or another other displayable device. In an embodiment, the display device 102 may include one or more speakers for rendering audio. Alternatively, one or more speakers for rendering audio may be coupled with an I/O interface unit. In alternate embodiments, one or more functions provided by the display system 604 may be on board an integrated circuit that also includes the processor 606. In addition, one or more of the functions provided by the bus interface unit 608 may be on board an integrated circuit that also includes the processor 606.

The I/O interface units support communication with a variety of storage and I/O devices. For example, the terminal interface unit 618 supports the attachment of one or more user I/O devices, which may include user output devices (such as a video display devices, speaker, and/or television set) and user input devices (such as a keyboard, mouse, keypad, touchpad, trackball, buttons, light pen, or other pointing devices). A user may manipulate the user input devices using a user interface, in order to provide input data and commands to the user I/O device 626 and the computing device 600, may receive output data via the user output devices. For example, a user interface may be presented via the user I/O device 626, such as displayed on a display device, played via a speaker, or printed via a printer.

The storage interface 620 supports the attachment of one or more disk drives or direct access storage devices 628 (which are typically rotating magnetic disk drive storage devices, although they could alternatively be other storage devices, including arrays of disk drives configured to appear as a single large storage device to a host computer, or solid-state drives, such as a flash memory). In another embodiment, the storage device 628 may be implemented via any type of secondary storage device. The contents of the memory 612, or any portion thereof, may be stored to and retrieved from the storage device 628 as needed. The I/O device interface 622 provides an interface to any of various other I/O devices or devices of other types, such as printers or fax machines. The network interface 624 provides one or more communication paths from the computing device 600 to other digital devices and computer systems.

Although the computing device 600 shown in FIG. 5 illustrates a particular bus structure providing a direct communication path among the processors 606, the memory 612, the bus interface 608, the display system 604, and the I/O bus interface unit 614, in alternative embodiments the computing device 600 may include different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface unit 614 and the I/O bus 608 are shown as single respective units, the computing device 600, may include multiple I/O bus interface units 614 and/or multiple I/O buses 616. While multiple I/O interface units are shown, which separate the I/O bus 616 from various communication paths running to the various I/O devices, in other embodiments, some or all of the I/O devices are connected directly to one or more system I/O buses.

In various embodiments, the computing device 600 is a multi-user mainframe computer system, a single-user system, or a server computer or similar device that has little or no direct user interface, but receives requests from other computer systems (clients). In other embodiments, the computing device 600 may be implemented as a desktop computer, portable computer, laptop or notebook computer, tablet computer, pocket computer, telephone, smart phone, or any other suitable type of electronic device.

In an embodiment, the memory 612 may include a random-access semiconductor memory, storage device, or storage medium (either volatile or non-volatile) for storing or encoding data and programs. In another embodiment, the memory 612 represents the entire virtual memory of the computing device 600, and may also include the virtual memory of other computer systems coupled to the computing device 600 or connected via a network 630. The memory 612 may be a single monolithic entity, but in other embodiments the memory 612 may include a hierarchy of caches and other memory devices. For example, memory may exist in multiple levels of caches, and these caches may be further divided by function, so that one cache holds instructions while another holds non-instruction data, which is used by the processor. Memory 612 may be further distributed and associated with different CPUs or sets of CPUs, as is known in any various so-called non-uniform memory access (NUMA) computer architectures.

The memory 612 may store all or a portion of the components and data shown in FIG. 1-5. In particular, the memory 612 may store the distributed services components 612A. In some embodiments, distributed services components 612A may include software applications and data structures for implementing execution system 105 (FIG. 1). The software applications and data structures may include components of service controller 110, resource manager 115, and configuration manager 120. In certain embodiments, distributed services component 612A may include software applications and data structures residing in service node 135 (FIG. 1). These software applications and data structures may include process execution unit 140, load information unit 145 distributed services instances 150, and measurement agents 160. The distributed services component 612A may additionally include computer executable code for orchestrating and performing operations of the components and flowcharts described in the discussion of FIGS. 1 and 5. The computer executable code may be executed by processor 606. Some or all of the components and data shown in FIG. 1-5 may be on different computer systems and may be accessed remotely, e.g., via a network 630. The computing device 600 may use virtual addressing mechanisms that allow the programs of the computing device 600 to behave as if they only have access to a large, single storage entity instead of access to multiple, smaller storage entities. Thus, while the components and data shown in FIG. 1-5 are illustrated as being included within the memory 612, these components and data are not necessarily all completely contained in the same storage device at the same time. Although the components and data shown in FIG. 1-5 are illustrated as being separate entities, in other embodiments some of them, portions of some of them, or all of them may be packaged together.

In an embodiment, the components and data shown in FIG. 1-5 may include instructions or statements that execute on the processor 606 or instructions or statements that are interpreted by instructions or statements that execute the processor 606 to carry out the functions as further described below. In another embodiment, the components shown in FIG. 1-5 may be implemented in hardware via semiconductor devices, chips, logical gates, circuits, circuit cards, and/or other physical hardware devices in lieu of, or in addition to, a processor-based system. In an embodiment, the components shown in FIG. 1-5 may include data in addition to instructions or statements.

FIG. 6 is intended to depict representative components of the computing device 600. Individual components, however, may have greater complexity than represented in FIG. 5. In FIG. 6, components other than or in addition to those shown may be present, and the number, type, and configuration of such components may vary. Several particular examples of additional complexity or additional variations are disclosed herein; these are by way of example only and are not necessarily the only such variations. The various program components illustrated in FIG. 6 may be implemented, in various embodiments, in a number of different ways, including using various computer applications, routines, components, programs, objects, modules, data structures etc., which may be referred to herein as “software,” “computer programs,” or simply “programs.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A system for managing a distributed service, comprising:
one or more compute nodes, each compute node having one or more computer processors and a memory;
a set of software services executing on the one or more processors, the set of software services including the distributed service;
a configuration manager executing on the one or more processors to store configuration information about the distributed service, the configuration information including a first criteria for transitioning the distributed service from a first execution state to an initialization state, the first criteria associating the first execution state of the distributed service with a second execution state of a first service of the set of software services;
a set of measuring agents executing on the one or more processors to obtain execution information from the set of software services; and
an execution system executing on the one or more processors and coupled to the configuration manager and the set of measuring agents, the execution system configured to:
determine, based on the execution information, whether the first criteria is satisfied; and
transition, in response to determining that the first criteria is satisfied, the distributed service from the first execution state to the initialization state.

2. The system of claim 1, wherein the configuration information further includes a second criteria for transitioning the distributed service from the initialization state to a third execution state, the second criteria associating the third execution state of the distributed service with a fourth execution state of a second service of the set of software services, and wherein the execution system is further configured to:
determine, based on the execution information, whether the second criteria is satisfied, and
transition, in response to determining that the second criteria is satisfied, the distributed service from the initialization state to the third execution state.

3. The system of claim 2, wherein the execution system determines, based on the second criteria, a startup sequence for the set of distributed services.

4. The system of claim 1, wherein the set of software services include at least one of an instance of the distributed service, and a software service distinct from the distributed service.

5. The system of claim 1, wherein a second service of the set of services includes an external interface for providing a first measurement agent of the set of measurement agents access to information about an internal state of the service.

6. The system of claim 1, wherein the execution system determines, based on the first criteria, a shutdown sequence for the set of software services.

7. The system of claim 1, wherein a software service includes a set of service instances, and execution system is further configured to:
store, for each software service in the set of software services, a set of one or more communication parameters, wherein a communication parameter is suitable for establishing communication between a software service and a service instance associated with the software service;

8. The system of claim 7, wherein the execution system is further configured to provide the communication parameter is at least one of the software service and the service instance associated with the software service.

9. The system of claim 7, wherein the communication parameter includes location information of at least one of the software service and the service instance associated with the software service.

10. A method for managing a distributed service executing on a computing system, the computing system providing a set of software services including the distributed service, the method comprising:
receiving, by a computing system, a first criteria for transitioning the distributed service from a first execution state to an initialization state, the first criteria associating the first execution state of the distributed service with a second execution state of a first software service of the set of software services;
receiving, from a set of measuring agents executing on the computing system, execution information about the set of software services; and
determining, based on the execution information, whether the first criteria is satisfied;
transitioning, in response to determining that the first criteria is satisfied, the distributed service from the first execution state to the initialization state.

11. The method of claim 10, further comprising:
receiving a second criteria for transitioning the distributed service from the initialization state to a third execution state, the second criteria associating the third execution state of the distributed service with a fourth execution state of a second service of the set of software services;
determining, based on the execution information, whether the second criteria is satisfied, and
transitioning, in response to determining that the second criteria is satisfied, the distributed service from the initialization state to the third execution state.

12. The method of claim 11, further comprising:
determining, based on the second criteria, a startup sequence for the set of distributed services.

13. The method of claim 10, wherein the set of software services includes at least one of an instance of the distributed service, and a software service distinct from the distributed service.

14. The method of claim 10, wherein a second service of the set of services includes an external interface for providing a first measurement agent of the set of measurement agents access to information about an internal state of the service.

15. The method of claim 10, further comprising:
determining, based on the first criteria, a shutdown sequence for the set of software services.

16. A computer program product for managing a distributed service executing on a computing system, the computing system providing a set of software services including the distributed service, the computer program product including a computer readable storage medium having program instructions embodied therewith, wherein the computer readable storage medium is not a transitory signal per se, the program instructions executable by a processing circuit to cause the processing circuit to perform a method comprising:
receiving, by a computing system, a first criteria for transitioning the distributed service from a first execution state to an initialization state, the first criteria associating the first execution state of the distributed service with a second execution state of a first software service of the set of software services;
receiving, from a set of measuring agents executing on the computing system, execution information about the set of software services; and
determining, based on the execution information, whether the first criteria is satisfied;
transitioning, in response to determining that the first criteria is satisfied, the distributed service from the first execution state to the initialization state.

17. The computer program product of claim 16, further comprising:
receiving a second criteria for transitioning the distributed service from the initialization state to a third execution state, the second criteria associating the third execution state of the distributed service with a fourth execution state of a second service of the set of software services;
determining, based on the execution information, whether the second criteria is satisfied, and
transitioning, in response to determining that the second criteria is satisfied, the distributed service from the initialization state to the third execution state.

18. The computer program product of claim 17, further comprising:
determining, based on the second criteria, a startup sequence for the set of distributed services.

19. The computer program product of claim 16, wherein the set of software services includes at least one of an instance of the distributed service, and a software service distinct from the distributed service.

20. The computer program product of claim 16, wherein a second service of the set of services includes an external interface for providing a first measurement agent of the set of measurement agents access to information about an internal state of the service.
